(19) United States
(12) Patent Application Publication
(10) Pub. No.: US 2026/0269548 A1
(43) Pub. Date: Sep. 10, 2026

(54) HOLDER FOR AXIAL BRUSH ASSEMBLY

(71) Applicant: AKTIEBOLAGET SKF, GOTEBORG (SE)

(72) Inventors: Mathieu HUBERT, Ann Arbor, MI (US); Gene Arthur KOVACS, Brighton, MI (US); David Christopher RYBSKI, White Lake, MI (US); William GEORGE, Ypsilanti, MI (US)

(21) Appl. No.: 19/069,502

(22) Filed: Mar. 4, 2025

(51) Int. Cl. H01R 39/39; H01R 39/38

(52) U.S. Cl. CPC H01R 39/39; H01R 39/383; H01R 39/385; H01R 2201/10

(57) ABSTRACT

A holder for a grounding brush assembly includes an elongated central hub having a centerline, opposing first and second axial ends spaced apart along the centerline, an inner circumferential surface defining a central bore extending between the first and second axial ends and sized to receive a portion of the fixed shaft, and an outer circumferential perimeter. A least one pair of retainer walls are integrally formed with the hub, each one of the pair of retainer walls extending radially outwardly from the outer circumferential perimeter of the hub and axially between the first and second axial ends of the hub. Each pair of retainer walls are spaced circumferentially apart so as to define an elongated groove configured to receive an axial conductive brush of the grounding brush assembly.

### BACKGROUND OF THE INVENTION

The present invention relates to grounding devices for bearings, and more particularly to grounding brush assemblies for shunting current away from bearings.

In electric machines, such as an electric motor, a generator, etc., the machine typically includes a shaft rotatable about a central axis, an outer housing and at least one bearing connecting the shaft to a housing. Such bearings generally include an inner ring mounted on the rotatable shaft, an outer ring disposed about the inner ring and engaged with the housing, and a plurality of rolling elements disposed between the inner and outer rings. During operation, electric charge may accumulate on the shaft, which can generate an electric current that passes from the shaft, through the bearing and into the outer housing. These currents can cause damage to the raceways of the inner and outer rings as well as to the rolling elements.

In order to avoid damage to the bearings, it is known to provide a grounding brush assembly that provides a conductive path between the shaft and the housing in order to shunt current away from the bearing(s). Such a grounding brush assembly typically includes a bracket or holder connected with the housing and a brush attached to the bracket/holder and including a plurality of conductive fibers extending radially inwardly from the holder and contacting the outer surface of the shaft, or a sleeve or other member mounted on the shaft. Alternatively, the holder may be mounted on the rotatable shaft and include a plurality of radially-outwardly directed fibers engaged with an inner circumferential surface of the housing.

### SUMMARY OF THE INVENTION

In one aspect, the present invention is a holder for a grounding brush assembly for an electric machine, the grounding brush assembly including at least one axial conductive brush and the electric machine including a hollow shaft, the hollow shaft being rotatable about a central axis and having a bore, and a fixed shaft extending through the bore of the hollow shaft. The holder comprises an elongated central hub having a centerline, opposing first and second axial ends spaced apart along the centerline, an inner circumferential surface defining a central bore extending between the first and second axial ends and sized to receive a portion of the fixed shaft, and an outer circumferential perimeter. A pair of retainer walls are integrally formed with the central hub, each one of the pair of retainer walls extending radially outwardly from the outer circumferential perimeter of the hub and axially between the first and second axial ends of the hub. The pair of retainer walls are spaced circumferentially apart so as to define an elongated groove configured to receive the axial brush of the brush assembly.

Preferably, each wall of the pair of retainer walls includes an elongated rectangular plate with an inner radial end integrally formed with the hub, an opposing outer radial end, and an inner and outer radial surfaces. The elongated groove is defined between the two inner radial surfaces of the pair of walls and a flat surface section formed on the outer circumferential perimeter of the hub and extending circumferentially between the pair of walls. Further, the pair of walls preferably converge radially outwardly such that a spacing distance between the outer ends of the pair of walls is less than a spacing distance between the inner ends of the pair of walls. Also, an elongated opening is defined between the outer ends of the pair of walls, the opening providing clearance for conductive fibers of the axial brush.

Further, the holder preferably comprises a plurality of the pairs of retainer walls spaced circumferentially apart about the centerline, each pair of retainer walls being integrally formed with hub. Each one of the walls of each pair of retainer walls extends radially outwardly from the outer circumferential perimeter of the hub and axially between the first and second axial ends of the hub. The two walls of each one of the plurality of pairs of retainer walls are spaced circumferentially apart so as to define an elongated groove configured to receive an axial brush of the brush assembly.

Furthermore, the hub preferably also includes at least one bearing mounting section disposed axially between one axial end of the hub and the pair of retainer walls. The bearing mounting section has a cylindrical outer circumferential surface configured to frictionally engage with an inner ring of a bearing to mount the bearing to the holder. As such, a centering bearing may be mounted to the grounding brush assembly.

In another aspect, the present invention is a grounding brush assembly including the holder as described above and further including at least one an axial conductive brush disposed within the elongated groove of the holder. The axial conductive brush includes a plurality of conductive fibers extending radially outwardly from and axially along the elongated groove, each conductive fiber having an inner radial end coupled with the holder and an outer radial end engageable with the inner circumferential surface of the hollow shaft. As such, at least one electrically conductive path extends from the hollow shaft, through the brush and the holder, and to the fixed shaft.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an electric machine with a grounding brush assembly including a holder in accordance with the present invention;

FIG. 2 is a perspective view of the grounding brush assembly with a holder in accordance with a first embodiment;

FIG. 3 is an exploded perspective view of the grounding brush assembly of the first embodiment;

FIG. 4 is an end plan view of the grounding brush assembly of the first embodiment;

FIG. 5 is a perspective view of the holder of the first embodiment;

FIG. 6 is an end plan view of the holder of the first embodiment;

FIG. 7 is a perspective view of a holder for a grounding brush assembly in accordance with a second embodiment, shown with one bearing mounting section;

FIG. 8 is a perspective view of the second embodiment grounding brush assembly; and

FIG. 9 is a perspective view of a second construction holder for the second embodiment grounding brush assembly, shown with two bearing mounting sections.

### DETAILED DESCRIPTION OF THE INVENTION

Certain terminology is used in the following description for convenience only and is not limiting. The words "inner", "inwardly" and "outer", "outwardly" refer to directions toward and away from, respectively, a designated centerline or a geometric center of an element being described, the particular meaning being readily apparent from the context of the description. Further, as used herein, the words "connected" and “coupled” are each intended to include direct connections between two members without any other members interposed therebetween and indirect connections between members in which one or more other members are interposed therebetween. The terminology includes the words specifically mentioned above, derivatives thereof, and words of similar import.

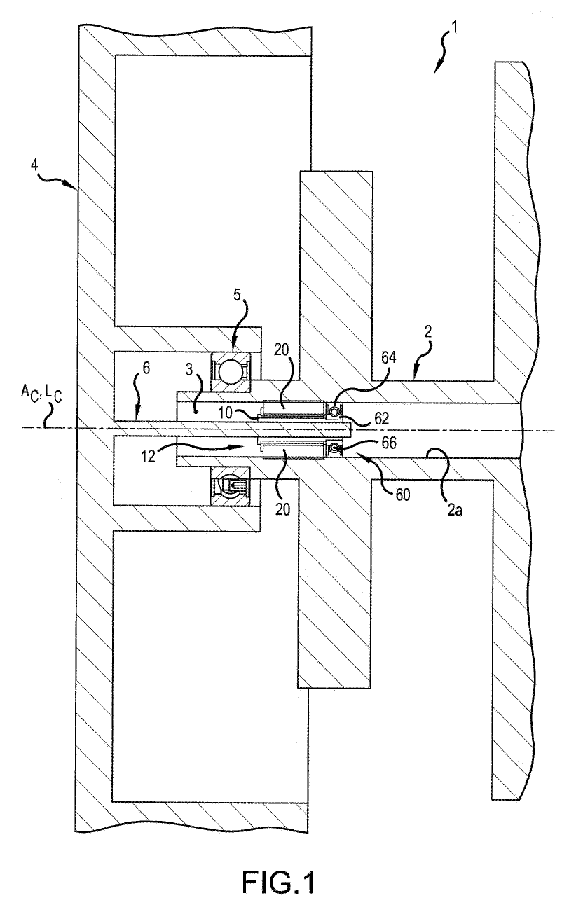

Referring now to the drawings in detail, wherein like numbers are used to indicate like elements throughout, there is shown in FIGS. 1-9 a holder 10 for a grounding brush assembly 12 for an electric machine 1. The electric machine 1 includes a hollow shaft 2 rotatable about a central axis A_{C} and having an inner circumferential surface 2a defining a hollow bore 3, an outer housing 4, at least one bearing 5 rotatably coupling the shaft 2 with the housing 4, and a fixed shaft 6 extending through the bore 3 of the rotatable shaft 2 and being electrically grounded. Preferably, the electric machine 1 is a motor for an electric vehicle, but may be any other appropriate electrical device which includes one or more bearings 5 for supporting a rotating shaft 2, for example, a motor for an industrial machine, a generator, etc.

In any case, the holder 10 basically comprises an elongated central hub 14 and a pair 16 of retainer walls 18A, 18B integrally formed with the hub 14 for receiving an axial conductive brush 20, and preferably a plurality of pairs 16 of integral walls 18A, 18B, such that the holder 10 is of one-piece construction. More specifically, the elongated central hub 14 has a centerline L_{C}, opposing first and second axial ends 14a, 14b spaced apart along the centerline L_{C}, an inner circumferential surface 22, and an outer circumferential perimeter 24. The inner circumferential surface 22 defines a central bore 23 extending between the first and second axial ends 14a, 14b and sized to receive a portion of the fixed shaft 6. Preferably, the circumferential outer perimeter 24 has a plurality of curved surface sections 25 each disposed between two adjacent pairs 16 of retainer walls 18A, 18B and a plurality of flat surface sections 26 extending between the two walls 18A, 18 of each pair 16. As such, the curved surface sections 25 and the flat surface sections 26 are formed alternating circumferentially about the centerline L_{C} of the central hub 14.

Further, each pair 16 of retainer walls 18A, 18B extend radially outwardly from the outer circumferential perimeter 22 of the hub 14 and axially between the first and second axial ends 14a, 14b of the hub 14. The two retainer walls 18A, 18B of each pair 16 are spaced circumferentially apart so as to define an elongated groove 28 for receiving one axial conductive brush 20, described in detail below. As mentioned above, the holder 10 preferably includes a plurality of the pairs 16 of retainer walls 18A, 18B spaced circumferentially apart about the centerline L_{C}, and most preferably four wall pairs 16, but may include only a single pair 16 of retainer walls 18A, 18B or any desired number of wall pairs 16, for example, five pairs 16, six pairs 16, eight pairs 16, etc.

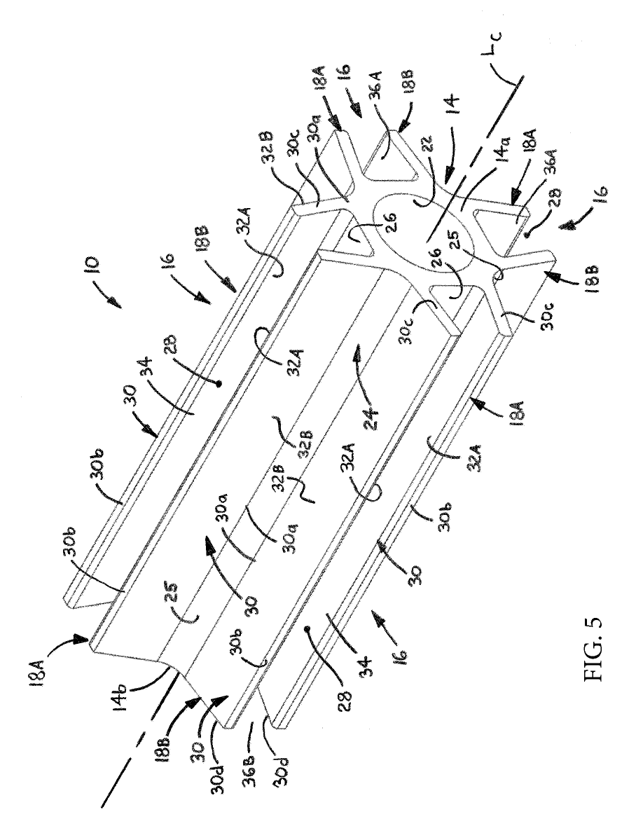

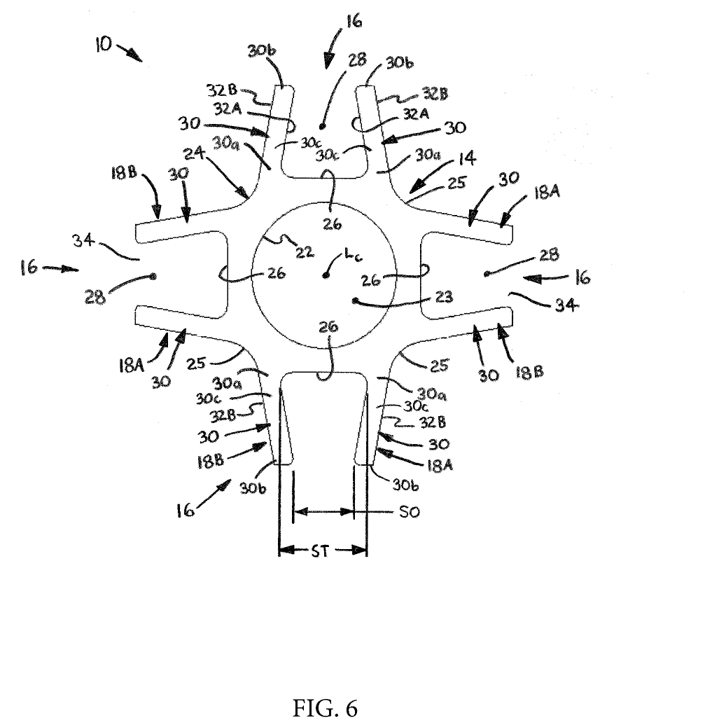

Referring now to FIGS. 5 and 6, each retainer wall 18A, 18B preferably includes, or is formed as, an elongated rectangular plate 30 with an inner radial end 30a integrally formed with the hub 12, an opposing, free outer radial end 30b, first and second axial ends 30c, 30d, respectively and inner and outer radial surfaces 32A, 32B, respectively. The elongated groove 28 of the pair 16 of retainer walls 18A, 18B is defined between the two inner radial surfaces 32A of the two walls 18A, 18B and the flat surface section 26 of the hub 14 extending circumferentially between the two walls 18A, 18B. Preferably, the retainer walls 18A, 18B are formed so as to converge radially outwardly, such that an outer spacing distance SO between the outer ends 30b of the two walls 18A, 18B is less than an inner spacing distance SI between the inner ends 30a of the walls 18A, 18B, as indicated in FIG. 6.

As such, each elongated groove 28 has generally wedge-shaped, or “dove-tailed”, radial cross-sections, as best shown in FIGS. 6, which function to radially retain the axial brush 20 disposed within the groove 28, as discussed below. Also, each plate 30 is preferably formed having a relatively minimal thickness (not indicated) between the inner and outer radial surfaces 32A, 32B. As such, each wall 18A, 18B is bendable about the wall inner end 30a to enable “crimping” of the walls 18A, 18B to axially retain a conductive brush 20. Additionally or alternatively, the inner surfaces 32A of the two retainer walls 18A, 18B may be configured to frictionally engage with a retainer 40 (described below) of the axial conductive brush 20 disposed between the walls 18A, 18B to axially retain the brush 20.

Further, an elongated opening 34 (FIG. 6) is defined between the outer ends 30b of the pair of walls 18A, 18B and provides clearance for the conductive fibers 21 of the axial brush 20 to extend radially outwardly from the groove 28. Furthermore, a first axial opening 36A is defined between the two first axial ends 30c of the two walls 18A, 18B of each pair 16 and a second axial opening 36B is defined between the two second axial ends of the two walls 18A, 18B, as indicated in FIG. 5. The two axial openings 36A, 36B enable installation of a conductive brush 20 into the associated groove 28, as described below.

Due to having a relatively simple one-piece structure described in detail above, the holder 10 may be readily manufactured by a variety of techniques, such for example, extrusion, casting, molding, sintering, additive manufacturing, etc., and is preferably formed of an electrically conductive material, such as aluminum, steel, stainless steel, a conductive polymer or any other appropriate conductive material. Once formed by any appropriate technique, at least one and preferably a plurality of axial conductive brushes 20 are each assembled to the holder 10 to form the grounding brush assembly 12, each brush 20 having a plurality of conductive fibers 21 for establishing conductive paths, as discussed below.

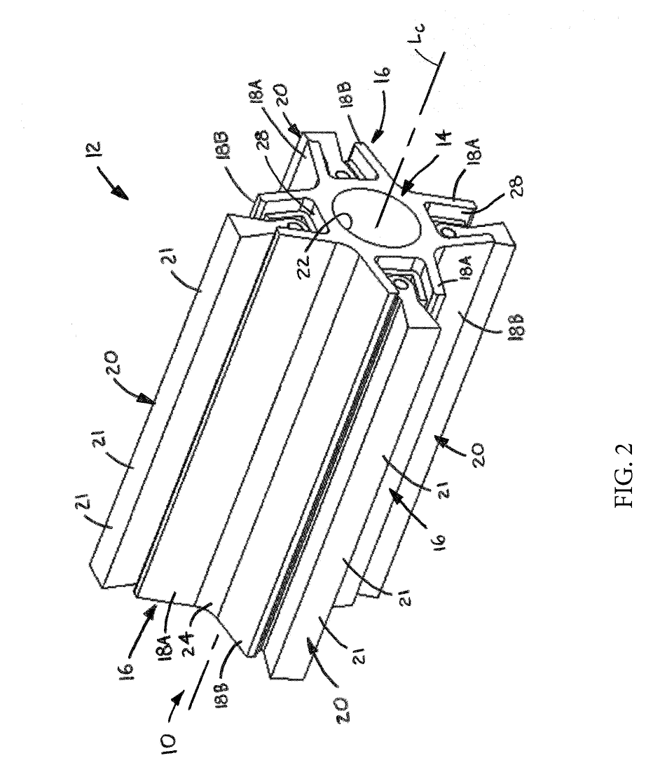

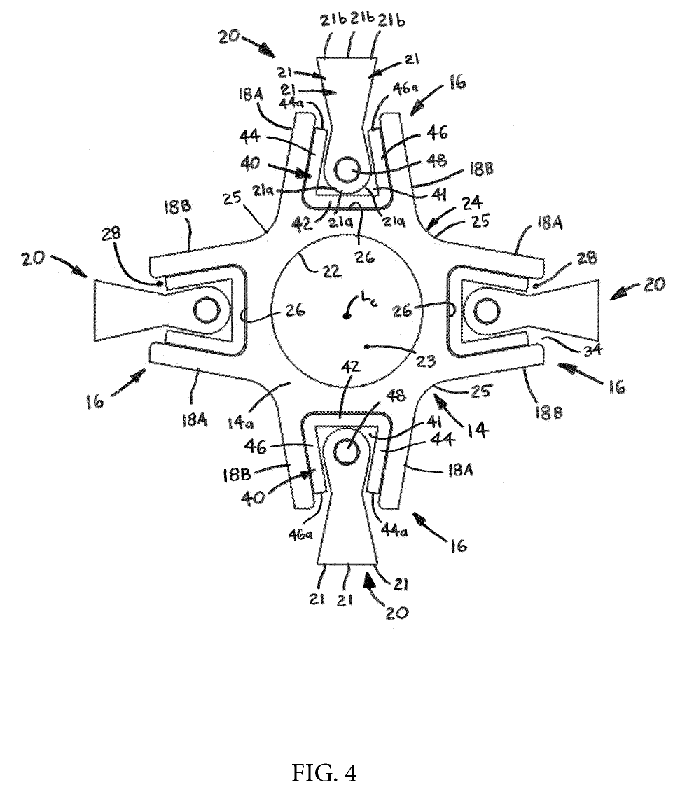

Referring now to FIGS. 2-4 and 8, each one of the preferred plurality of axial conductive brushes 20 is disposed within a separate one of the elongated grooves 28 of the holder 10. When installed within a groove 28, the plurality of conductive fibers 21 of each brush 20 extends both radially outwardly from and axially along the groove 28. Each conductive fiber 21 has an inner radial end 21a coupled with the holder 10 and an outer radial end 21b engageable with the inner circumferential surface 2a of the rotatable shaft 2, as indicated in FIG. 4. As such, at least one and preferably a plurality of electrically conductive paths (none indicated) extend from the rotatable hollow shaft 2, through the brush(es) 20 and the holder 10, and to the fixed shaft 6. By providing such conductive path(s), any charge accumulating on the hollow shaft 2 is diverted through the grounding brush assembly 12, and thereafter to ground, rather than passing through the bearing(s) 5.

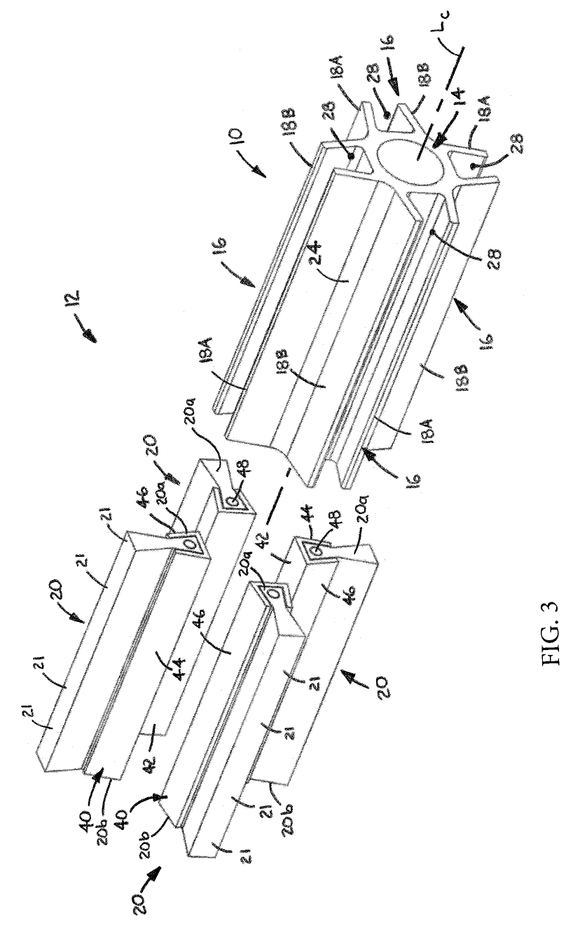

As best shown in FIGS. 3 and 4, each axial conductive brush 20 preferably includes a retainer 40 with an elongated base wall 42 and two spaced apart elongated sidewalls 44, 46 extending radially from the base wall 42 so as to define an axial channel 41. The plurality of conductive fibers 21 are disposed between and engaged by the two side walls 44, 46 so as to retain the conductive fibers 21 within the axial channel 41 (FIG. 4). Specifically, the two side walls 44, 46 extend radially converging from the base wall 42 such that the outer ends 44a, 46a of the two side walls 44, 46 “pinch” together the plurality of conductive fibers 21 to retain the fibers 21 disposed within the axial channel 41.

Preferably, each conductive fiber 21 is wound about a retainer wire 48 that extends along the upper surface of the base wall 42. As such, each fiber 21 preferably has a bent section (not indicated) disposed between the retainer wire 48 and the base wall 42 and providing the radial inner end 21a of the conductive fiber 21 and two legs (not indicated) extending radially from the bent portion and providing two outer ends 21b of each conductive fiber 21. Further, the retainer 40 is formed of an electrically conductive material, such as steel, aluminum, a conductive polymer, etc., and each conductive fiber 21 is a strand of an electrically conductive material, preferably carbon but may be formed of steel, aluminum, a conductive polymer, etc.

Further, each axial conductive brush 20 is assembled into the holder 10 by inserting one axial end 20a or 20b (FIG. 3) of the brush 20 through either axial opening 36A or 36B of the preferred plurality of pairs 16 of retainer walls 18A, 18B. The conductive brush 20 is pushed axially through the elongated groove 28 between the two walls 18A, 18B until the brush 20 is entirely disposed within the groove 28. When disposed within the groove 28, the radially outer sections of all of the conductive fibers 21 extend through the elongated opening 34 between the two retainer walls 18A, 18B of each wall pair 16 such that the radial outer ends 21b of the conductive fibers 21 are spaced radially outwardly from the outer ends 30b of the two walls 18A, 18B. Thereby, the outer ends 21b of the conductive fibers 21 are located to be engageable with the inner surface 2a of the hollow shaft 2.

Further, after a conductive brush 20 is installed within the holder 10, each pair 16 of retainer walls 18A, 18B may be bent toward each other so as to crimp the conductive brush 20 between the two walls 18A, 18B and prevent any axial displacement of the brush 20. Alternatively, the conductive brush 20 may be maintained within the associated groove 28 either by twisting the holder 10 along the centerline L_{C}, such that the brush assembly 12 is slightly helical, or by sizing the groove 28 such that the inner surfaces 32A of the retainer walls 18A, 18B frictionally engage with the sidewalls 44, 46 of the brush retainer 40. In any of these cases, no separate retention member(s), for example a C-clip, are required to retain each axial conductive brush 20 within the associated groove 28.

Once all of the axial conductive brushes 20 are installed within the holder 10, the assembled grounding brush assembly 12 may be mounted to the fixed shaft 6 by inserting the fixed shaft 6 into the central bore 23 of the holder 10 until positioned at a desired location along the central axis A_{C}. The grounding brush assembly 12 is retained at the desired location by a friction fit between the inner circumferential surface 22 of the holder 10 and the outer circumferential surface (not indicated) of the fixed shaft 6. Also, the outer ends 21b of the plurality of conductive fibers 21 of each axial conductive brush 20 are engaged with the inner surface 2a of the rotatable hollow shaft 2. As a result, any charge accumulating on the rotatable hollow shaft 2 may pass through one or more of the conductive fibers 21, through the brush retainer 40, through the holder 10 and into the fixed shaft 6 so as to pass through to ground.

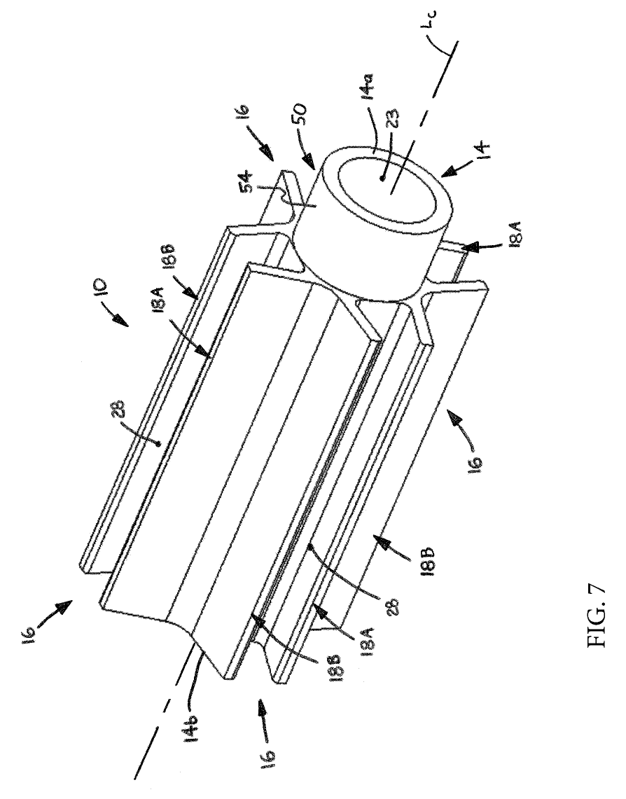

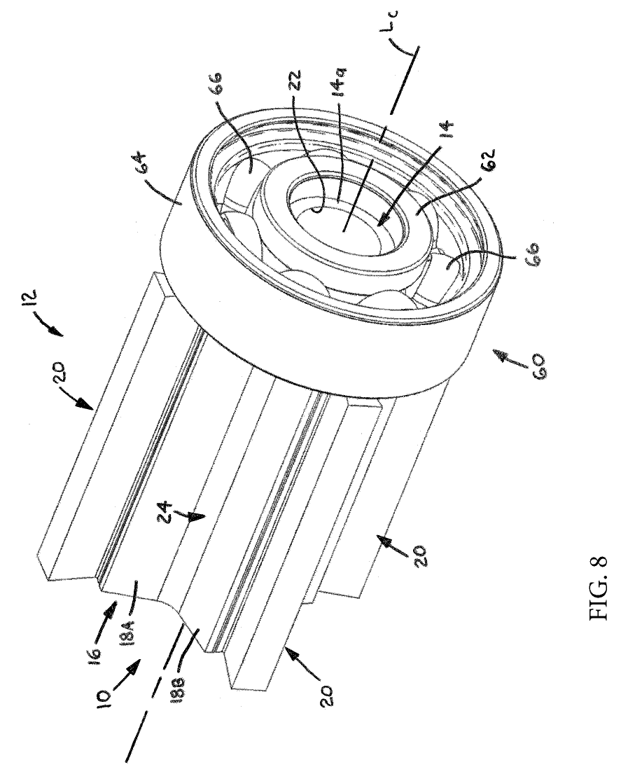

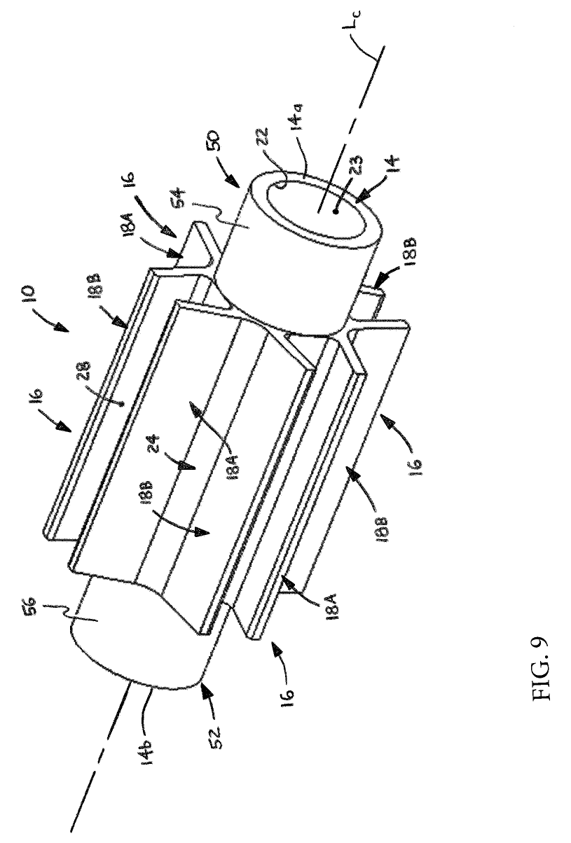

Referring now to FIGS. 7-9, in an alternative embodiment, the holder 10 may include one or two bearing mounting sections 50, 52 for mounting the inner ring 62 of a centering bearing 60 to the grounding brush assembly 12. Specifically, in one construction shown in FIGS. 7 and 8, the central hub 14 includes a single bearing mounting section 50 disposed axially between one axial end 14a (or 14b) of the hub 14 and the one or more pairs 16 of retainer walls 18A, 18B. In another construction depicted in FIG. 9, the central hub 14 includes first and second bearing mounting section 50, 52, respectively, each disposed between a separate one of the axial ends 14a, 14b of the hub 14 and the one or more pairs 16 of retainer walls 18A, 18B, such that the walls 18A, 18B are disposed centrally between the two bearing mounting sections 50, 52. In either case, each bearing mounting section 50, 52 has a cylindrical outer circumferential surface 54, 56, respectively, configured to frictionally engage with the inner ring 62 of the bearing 60 so as to mount the bearing 60 to the holder 10. The bearing mounting section(s) 50, 52 may be formed by machining off axial end sections of the retainer walls 18A, 18B when the holder 10 is formed in an extrusion process and is alternatively formed directly on central hub 14 when the holder is formed by casting, molding or sintering.

In the alternative embodiment, the grounding brush assembly 12 preferably further comprises at least one centering bearing 60 having an inner ring 62 disposed on the bearing mounting section 50 or 52 of the holder 10 and an outer ring 64 engageable with the inner circumferential surface 2a of the rotatable hollow shaft 2, as shown in FIGS. 1 and 8. Preferably, the centering bearing 60 further includes a plurality of rolling elements 66 disposed between the inner and outer rings 62, 64, but may be configured as a bushing or plain bearing without any rolling elements. The one or more centering bearings 60 each function to couple the hollow shaft 2 with the fixed shaft 6 so as to stiffen and prevent vibration of the fixed shaft 6, and does not primarily serve to support any loading between the two shafts 2, 6.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A holder for a grounding brush assembly for an electric machine, the grounding brush assembly including at least one axial conductive brush and the electric machine including a hollow shaft, the hollow shaft being rotatable about a central axis and having a bore, and a fixed shaft extending through the bore of the hollow shaft, the holder comprising:
an elongated central hub having a centerline, opposing first and second axial ends spaced apart along the centerline, an inner circumferential surface defining a central bore extending between the first and second axial ends and sized to receive a portion of the fixed shaft, and an outer circumferential perimeter; and
a pair of retainer walls integrally formed with the hub, each one of the pair of retainer walls extending radially outwardly from the outer circumferential perimeter of the hub and axially between the first and second axial ends of the hub, the pair of retainer walls being spaced circumferentially apart so as to define an elongated groove configured to receive the axial brush of the brush assembly.

2. The holder as recited in claim 1, wherein each wall of the pair of walls is configured to bend toward the other wall of the pair of walls so as to axially retain an axial brush disposed between the pair of walls.

3. The holder as recited in claim 1, wherein each wall of the pair of retainer walls includes an elongated rectangular plate with an inner radial end integrally formed with the hub, an opposing outer radial end, and an inner and outer radial surfaces, the elongated groove being defined between the two inner radial surfaces of the pair of walls and a flat surface section formed on the outer circumferential perimeter of the hub and extending circumferentially between the pair of walls.

4. The holder as recited in claim 3, wherein the pair of retainer walls converge radially outwardly such that a spacing distance between the outer ends of the pair of walls is less than a spacing distance between the inner ends of the pair of walls; and

5. The holder as recited in claim 3, wherein an elongated opening is defined between the outer ends of the pair of retainer walls, the opening providing clearance for conductive fibers of the axial brush.

6. The holder as recited in claim 3, wherein each wall of the pair of retainer walls has a first axial end and a second axial end, a first axial opening being defined between the two first axial ends of the pair of walls and a second axial opening being defined between the two second axial ends of the pair of walls, each one of the first and second axial openings being configured to receive an axial end of the axial brush such that the brush is installed by inserting the axial end into one of the first and second axial openings.

7. The holder as recited in claim 1, wherein the pair of retainer walls is a first pair of retainer walls and the holder further comprises a second pair of retainer walls spaced circumferentially apart from the first pair of retainer walls and integrally formed with the hub, each one of the second pair of retainer walls extending radially outwardly from the outer circumferential perimeter of the hub and axially between the first and second axial ends of the hub, the second pair of retainer walls being spaced circumferentially apart so as to define an elongated groove configured to receive another axial brush of the brush assembly.

8. The holder as recited in claim 1, wherein the holder comprises a plurality of pairs of retainer walls spaced circumferentially apart about the centerline, each pair of retainer walls being integrally formed with hub, each one of the walls of each pair of retainer walls extending radially outwardly from the outer circumferential perimeter of the hub and axially between the first and second axial ends of the hub, the two walls of each one of the plurality of pairs of retainer walls being spaced circumferentially apart so as to define an elongated groove configured to receive an axial brush of the brush assembly.

9. The holder as recited in claim 1, wherein the hub includes a bearing mounting section disposed axially between one axial end of the hub and the pair of retainer walls and having a cylindrical outer circumferential surface configured to frictionally engage with an inner ring of a bearing to mount the bearing to the holder.

10. The holder as recited in claim 9, wherein the bearing mounting section is a first bearing mounting section and the hub further includes a second bearing mounting section disposed axially between the other axial end of the hub and the pair of retainer walls, the second bearing mounting section having an outer circumferential surface configured to frictionally engage with an inner ring of another bearing to mount the other bearing to the holder.

11. A grounding brush assembly for an electric machine, the electric machine including a hollow shaft, the hollow shaft being rotatable about a central axis and having an inner circumferential surface defining a bore, and a fixed shaft extending through the bore of the hollow shaft, the brush assembly comprising:
a holder including:
an elongated central hub having a centerline, opposing first and second axial ends spaced apart along the centerline, an inner circumferential surface defining a central bore extending between the first and second axial ends and sized to receive a portion of the fixed shaft, and an outer circumferential perimeter; and
a pair of retainer walls integrally formed with the hub, each one of the pair of retainer walls extending radially outwardly from the outer circumferential perimeter of the hub and axially between the first and second axial ends of the hub, the pair of retainer walls being spaced circumferentially apart so as to define an elongated groove; and
an axial conductive brush disposed within the elongated groove of the holder and including a plurality of conductive fibers extending radially outwardly from and axially along the elongated groove, each conductive fiber having an inner radial end coupled with the holder and an outer radial end engageable with the inner circumferential surface of the hollow shaft such that at least one electrically conductive path extends from the hollow shaft, through the brush and the holder, and to the fixed shaft.

12. The grounding brush assembly as recited in claim 11, wherein each wall of the pair of retainer walls includes an elongated rectangular plate with an inner radial end integrally formed with the hub, an opposing outer radial end, and an inner and outer radial surfaces, the elongated groove being defined between the two inner radial surfaces of the pair of walls and a flat surface section formed on the outer circumferential perimeter of the hub and extending circumferentially between the pair of walls.

13. The holder as recited in claim 12, wherein the elongated plate of each wall is configured to bend about the inner radial end of the plate toward the elongated plate of the other wall so as to axially retain the axial brush disposed between the pair of walls.

14. The grounding brush assembly as recited in claim 12, wherein:
the pair of retainer walls converge radially outwardly such that a spacing distance between the outer ends of the pair of walls is less than a spacing distance between the inner ends of the pair of walls; and
the axial brush includes a retainer member including a base wall with opposing elongated ends and a pair of sidewalls, each sidewall extending radially outwardly from a separate one of the elongated ends of the base wall and being disposed against a separate one of the pairs of walls of the holder.

15. The grounding brush assembly as recited in claim 11, wherein:
the hub includes a bearing mounting section disposed axially between one axial end of the hub and the pair of retainer walls and having a cylindrical outer circumferential surface;
the grounding brush assembly further comprises a centering bearing including a bearing inner ring frictionally engaged with the cylindrical surface of the bearing mounting section of the holder and an outer ring frictionally engageable with the inner circumferential surface of the hollow shaft.

16. The grounding brush assembly as recited in claim 11, wherein the at least one axial brush includes a retainer with a base wall and two spaced apart sidewalls extending radially from the base wall so as to define an axial channel, the plurality of conductive fibers being disposed between and engaged by the two side walls so as to retain the conductive fibers within the axial channel, each sidewall of the retainer being disposed against and engaged with one of the pair of walls to retain the axial brush within the elongated groove of the holder.

17. A holder for a grounding brush assembly for an electric machine, the grounding brush assembly including a plurality of axial brushes and the electric machine including a hollow shaft, the hollow shaft being rotatable about a central axis and having a bore, and a fixed shaft extending through the bore of the hollow shaft, the holder comprising:
an elongated central hub having a centerline, opposing first and second axial ends spaced apart along the centerline, an inner circumferential surface defining a central bore extending between the first and second axial ends and sized to receive a portion of the fixed shaft, and an outer circumferential perimeter; and
a plurality of pairs of retainer walls integrally formed with the hub and spaced circumferentially apart about the centerline, each one of the walls of each pair of retainer walls extending radially outwardly from the outer circumferential perimeter of the hub and axially between the first and second axial ends of the hub, the two walls of each one of the plurality of pairs of retainer walls being spaced circumferentially apart so as to define an elongated groove configured to receive a separate one of the plurality of axial brushes.

18. The holder as recited in claim 17, wherein each wall of each one of the plurality of pairs of retainer walls includes an elongated rectangular plate with an inner radial end integrally formed with the hub, an opposing outer radial end, and an inner and outer radial surfaces, the elongated groove being defined between the two inner radial surfaces of the pair of walls and a flat surface section formed on the outer circumferential perimeter of the hub and extending circumferentially between the pair of walls.

19. The holder as recited in claim 18, wherein at least one of:
the walls of each one of the plurality of pairs of walls converge radially outwardly such that a spacing distance between the outer ends of the pair of walls is less than a spacing distance between the inner ends of the pair of walls;
an elongated opening is defined between the outer ends of each one of the plurality of pairs of walls, the opening providing clearance for conductive fibers of the axial brush; and
each wall of the plurality of pairs of walls has a first axial end and a second axial end, a first axial opening being defined between the two first axial ends of the pair of walls and a second axial opening being defined between the two second axial ends of the pair of walls, each one of the first and second axial openings being configured to receive an axial end of the axial brush such that the brush is installed by inserting the axial end into one of the first and second axial openings.

20. The holder as recited in claim 17, wherein the hub includes a bearing mounting section disposed axially between one axial end of the hub and the pair of retainer walls and having a cylindrical outer circumferential surface configured to frictionally engage with an inner ring of a bearing to mount the bearing to the holder.
